(19) United States
(12) Patent Application Publication
(10) Pub. No.: US 2008/0244437 A1
(43) Pub. Date: Oct. 2, 2008

(54) Quick Glance Maintenance Interface for an Analytical Device

(76) Inventor: Gregory T. Fischer, Glen Mills, PA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/693,592

(22) Filed: Mar. 29, 2007

(51) Int. Cl. G06F 3/048

(52) U.S. Cl. 715/772

(57) ABSTRACT

A graphical user interface for monitoring an analytical device. A first section displays a plurality of maintenance information fields for a component in the analytical device that has a specified lifetime. The plurality of maintenance information fields includes an image representing a usage state of the component, and a graphical representation of the consumed portion of the specified lifetime. A second section sets a threshold used to determine the usage state of the component.

### BACKGROUND

Analytical devices are used to analyze biological and chemical substances. Analytical devices include, but are not limited to: gas chromatographs, liquid chromatographs, mass spectrometers, other chromatographic and spectrometry devices, and chromatographic and spectrometry accessories such as sample introduction and automation devices, trays, injector towers, pumps, auto-samplers, headspace samplers, etc. An analytical device contains components that must be maintained (e.g. periodically repaired or replaced) to keep the analytical device running in good order. For example, a column in a gas chromatograph needs to be replaced after it has gone through a certain number of oven cycles. Similarly, an inlet septum of a gas chromatograph needs to be changed after a certain number of injections. Therefore, a user of an analytical device needs to track maintenance information, such as when a component was last maintained, and when the next maintenance action on that component should be performed. This information allows the user to schedule the needed maintenance, order any replacement parts, etc. with enough advance notice to minimize the downtime of the analytical device.

However, there are many different components within an analytical device that need maintenance, and it can be difficult for a user to track each component and determine when maintenance needs to be performed. This is especially true when multiple components are being monitored. Tracking component maintenance is even more complicated when there are multiple users of the analytical device. In multi-user situations, it is not easy to determine who is responsible for tracking and maintenance of the components. The possibility of human error increases in such situations.

### BRIEF DESCRIPTION OF THE DRAWINGS

FIG. 1 illustrates a block diagram of an exemplary system for tracking component maintenance in which the present invention may be practiced.

FIG. 2 illustrates one embodiment of a graphical user interface (GUI) for tracking component maintenance.

FIG. 3 shows one embodiment of the GUI, in an actual reduction to practice.

### DETAILED DESCRIPTION

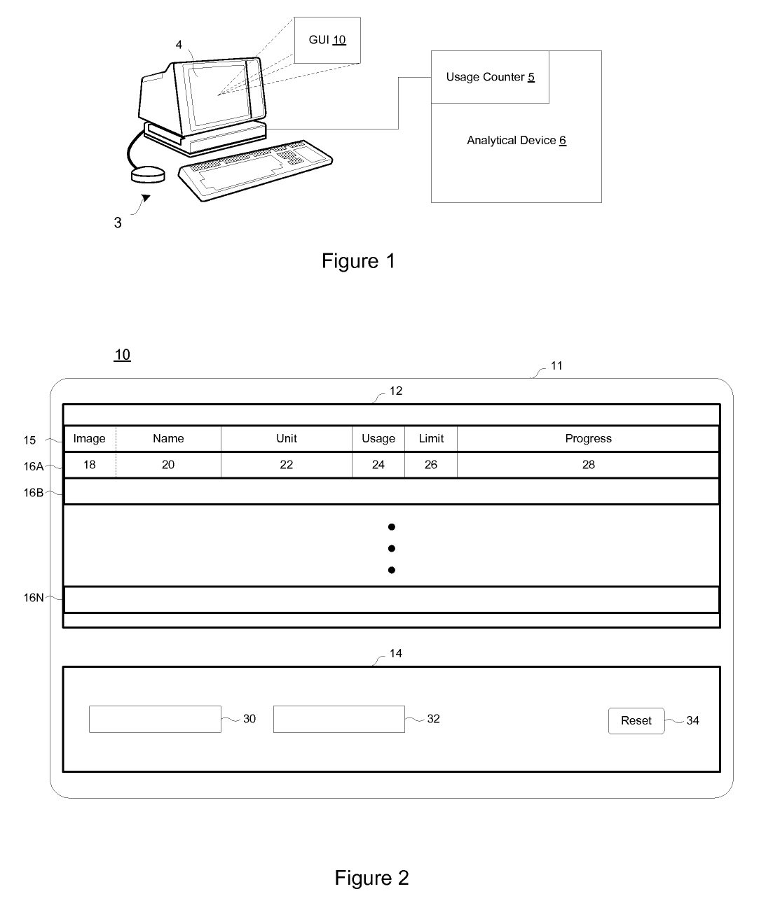

FIG. 1 illustrates a block diagram of an exemplary system 2 for tracking component maintenance in which the present invention may be practiced. A processing unit 3 having a display 4 is in electrical communication with a usage counter 5 that resides within an analytical device 6. For the sake of convenience, all examples and illustrations hereinafter shall assume that the analytical instrument is a gas chromatograph (GC). However, it should be understood that the present invention is not limited to gas chromatographs and is applicable to all analytical instruments having components with measurable lifetimes.

The processing unit 3 in FIG. 1 is shown as an external computer, but can be any device having a processor and a corresponding display. For example, the processing unit 3, the display 4, or both the processing unit 3 and the display 4, can be located within the analytical device 6 itself.

A GUI 10 for tracking the maintenance status of components in the analytical device 6 is located in the display 4. The GUI 10 may be implemented in software or firmware, using any programming language suitable for building graphical user interfaces. In an actual reduction to practice, the GUI 10 was implemented using Microsoft's C-sharp (C-#, .NET 2.0). Other exemplary languages include (but are not limited to): Microsoft Managed C++.NET, and Microsoft Visual Basic .NET.

Each component monitored by the GUI 10 has a measurable lifetime, meaning that the component has a productive lifespan that can be measured in some manner, e.g. in terms of time, number of uses, number of injection cycles, length, volume, temperature, counter, a counting unit specific to the component, etc. During the lifetime, the consumed portion of the lifetime (i.e. the portion of the productive lifespan that has been consumed or used up) is tracked and displayed by the GUI 10. At the end of its lifetime, replacement of the component is necessary to ensure that the analytical device (in which the component is found) performs as expected by the user. A default lifetime may be assigned by the manufacturer of the analytical device but this default can be modified by the end user as well.

The manner in which the consumed portion of a component's lifetime is actually measured will depend on the analytical device and the units being used to measure the lifetime of the component. For example, if the lifetime is being measured in terms of time, then the GUI 10 can rely on an internal clock (such as one used by the processing unit 3) to track the passage of time.

If the lifetime of the component is being measured in terms of number of uses (e.g. number of injection cycles or number of oven cycles for a GC), then there are a few other possibilities. For example, many analytical devices have an internal usage counter 5 which the processing unit 3 can query, as shown in FIG. 1. The usage counter 5 counts the number of measurement cycles, oven cycles, injections, and any other applicable counting units that may be tracked within the analytical device 4. The processing unit 3 queries the usage counter 5 to determine the number of uses (in the desired measurement units) elapsed for the component in question.

However, some analytical devices lack a usage counter 5. In these situations, the processing unit 3 should be set up to communicate with the user interface for the analytical device and count the number of “start cycle” commands issued to the analytical device.

FIG. 2 illustrates one embodiment of the graphical user interface (GUI) 10 for tracking component maintenance. The GUI 10 as shown has a main window 11 with two sections: a display window 12, and a control window 14. The configuration of the windows in the GUI 10 is not limited to the example shown in FIG. 2. For example, the placement of the display window 12 and control window 14 relative to one another in the main window 11 can be rearranged. Or, the control window 14 can be left out of the main window 11 altogether—instead, the control window 14 can be brought up using a button or menu option in the GUI 10, or implemented using another window or submenu accessible through a special key or mouse click sequence, etc. The display window 12 may appear in a completely different display than the control window 14 altogether. For example, the display window 12 may appear on a computer display, whereas the control window 14 may appear on a display on the analytical device, or vice versa.

### Display Window

The display window 12 has rows 15 and 16A-N. Row 15 is a header row for rows 16A-N. Each one of rows 16A-N corresponds to a monitored component within the analytical device. Within each row 16 are fields of maintenance information relating to the monitored component. In one embodiment (as illustrated in FIG. 1), each row is divided into 6 columns of maintenance information. The first column is a image field 18, the second column is a component name field 20, the third column is a unit field 22, the fourth column is a usage field 24, the fifth column is a limit field 26, and the sixth column is a progress field 28. Row 15 is divided into sections that line up with the columns in rows 16A-N below, each section of row 15 describing the contents of the column below. The rows 16A-N can be sorted by column by clicking on the appropriate section in the header row 15.

The image field 18 displays an image that represents the usage state of the component. The usage state of the component depends on how much of the component's lifetime has been consumed. For example, a good state corresponds to a component which has a consumed lifetime that is below a certain threshold. A warning state corresponds to a component which has a consumed lifetime that is above a certain threshold. And an error state corresponds to a component which has completely used up its lifetime. In one embodiment, the image field 18 shows a warning icon when the consumed lifetime reaches a specified percentage set by the user, then shows an error icon when the consumed lifetime reaches 100 percent. Some examples of suitable warning icons include: a warning sign, a yellow-colored shape, a blue circle with the letter “i” inside, or any other icon recognized by the user as representing a warning. Some examples of suitable error icons include: a stop sign, a red-colored shape, a yellow-colored shape, or any other icon recognized by the user as representing an error. The image field 18 allows the user to quickly determine the usage state of the component (e.g. good, warning, error) with a single glance. The thresholds in the component lifetime for determining the usage state of the component are set by the user in the control window 14, which is discussed in more detail below.

The component name field 20 displays the name of the monitored component. For example, if the monitored component was a septum in a GC, then the word “septum” could appear in this field 20 to describe the component. The component name field 20 should be a unique identifier for the component. When multiple analytical device are being monitored, the component name field should include a unique identifier for the analytical device in which the component is found. Alternatively, an additional field could be included in the display window 12 for identifying the analytical device.

The unit field 22 displays the units in which the lifetime of the monitored component is measured. The units used to measure the lifetime will vary from one analytical device to the next, and from one component to the next. For example, the column in a GC is one component that needs to be periodically replaced, as previously mentioned, or else the accuracy of the instrument will suffer. The lifetime of the column could be measured in units of time (e.g. seconds, minutes, days, weeks, months, etc.) in units of cycles (e.g. injection cycles, oven cycles, etc.). The units available for measuring the lifetime can be chosen by the manufacturer.

In one embodiment, a user may even define their own units for measuring the lifetime. For example, it may be desirable to replace/repair the column after a certain number of cycles run by a user X.

The usage field 24 displays the consumed portion of the component's lifetime in numeric form. For example, if the lifetime of a GC column is being measured in terms of days, and a new GC column was installed 3 days ago, then the usage field 24 would indicate 3 days. Similarly, if the lifetime of the GC column is being measured in terms of oven cycles, and a new GC column was installed 15 oven cycles ago, then the usage field 24 would indicate 15 oven cycles.

The limit field 26 displays the lifetime of the component in numeric form. As previously mentioned, a default lifetime may be assigned by the manufacturer of the analytical device but this default can and most likely will be modified by the end user. The length of the lifetime will vary, depending on the user's needs and the particular application of the analytical device. Consider a split-inlet o-ring in a GC as an example: one user may want to input a shorter lifetime to change out the o-ring sooner, whereas another user who has more tolerance for error could input a longer lifetime to change the o-ring out later.

The same component may be listed more than once in the display window. For example, it may be necessary to count both the oven cycles and injection cycles that a column has been through. Under such circumstances, a first row 16 can be used to monitor the column using units of oven cycles, and a second row 16 can be used to monitor the column using units of injection cycles. A third row can be added to monitor the column using units of time, and so on and so forth.

The progress field 28 displays a progress bar that indicates what portion of the component's lifetime has been consumed. In one embodiment, the color of the progress bar also indicates the usage state of the component. For example, the progress bar can be green when the consumed portion of the component's lifetime is below a certain threshold, yellow when the consumed portion of the lifetime is above a certain threshold, and red when the end of the lifetime has been reached. More detail on how the color of the progress bar changes with respect to the lifetime is given below in the section describing the control window 14. This progress field 28 provides the user with a graphical representation of the consumed portion of the component's lifetime. The progress field 28 allows the user to quickly approximate the percentage of the component's lifetime that has been consumed so far. The progress field 28 is not limited to a progress bar—other graphical representations of the consumed lifetime (e.g. pie charts, gauges, etc.) can also be used.

In one embodiment, the progress field 28 also displays the consumed portion of the lifetime in a numeric percentage next to the progress bar itself. This numeric percentage is simply the value in the usage field 24 divided by the value in the limit field 26.

It should be understood that the order of the columns shown is not critical, and that the columns may be switched around without departing from the teachings of the present invention.

The display window 12 provides the user with a lot of information in a quick glance. The user can quickly see a graphical representation of the state of the analytical device (e.g. via the image field 18 and the progress field 28) as well as access more detailed numeric information (e.g. the usage field 24 and limit field 26) at the same time, all in the same window. The image field 18 and progress field 28 allow the user to quickly focus on components that have remaining lifetimes below a certain threshold. The user can ignore the details of any component which has an acceptable remaining lifetime (but such details are readily available if needed).

### Control Window

The control window 14 gives the user the ability to set the lifetime for each component and reset the consumed portion. Using control window 14, the user is also able to set thresholds within the lifetime. These thresholds determine the usage state of the component. Furthermore, when these thresholds are reached, various actions may be taken to alert the user to a change in the usage state of the component. Any action taken in the control window 14 applies only to the selected component in the display window 12. The selection of a component can be made by selecting (e.g. clicking, highlighting, flagging, marking) the appropriate row 16A-16N corresponding to the desired component. In one embodiment, multiple components can be selected simultaneously, and the action taken in the control window 14 applies to all the selected components.

The lifetime of the selected component is entered into lifetime field 30. For example, if the selected component was a GC column, the user could enter a value of X cycles. As previously mentioned, the manufacturer can enter a default value, but many users will want to customize the lifetimes on many components to fit their own particular needs and applications. When the entire lifetime of a particular component has been consumed, the component enters an error state and an error action can be taken. The particular error action taken by the GUI 10 (e.g. sending an email alert, flashing an error pop-up window in the GUI 10, triggering an error LED on the analytical device itself, playing an audible error sound, etc.) will vary depending on the application and needs of the user.

A warning threshold is entered into threshold field 32. The warning threshold is a value entered by the user, which indicates the point in the component's lifetime at which the user wants to be automatically alerted as to the usage status of the component. For example, the warning threshold can be chosen at a point which gives the user reasonable forewarning and opportunity to arrange for replacement or repair of the component before the lifetime is over. In one embodiment, multiple warning thresholds can be used. When the consumed lifetime of a particular component reaches the warning threshold, the component enters a warning state and a warning action can be taken. The particular warning action taken by the GUI 10 (e.g. sending an email alert, flashing a warning pop-up window in the GUI 10, triggering a warning LED on the analytical device itself, playing an audible warning sound, etc.) will vary depending on the application and needs of the user.

A reset button 34 allows the user to reset the consumed portion of a component's lifetime to zero (or other appropriate initial value) with a single click. This allows the user to easily reset the component's lifetime whenever a component has been replaced or repaired.

As previously described, the color of the progress bar can be changed to indicate how much of the lifetime has been consumed. The warning threshold established in the threshold field 32 can be used to determine the color of the progress bar. For example, the progress bar can be a color indicating an “OK” status (e.g. green or some other user-recognized “OK” color) when the component's consumed lifetime is below the warning threshold. The progress bar can be changed to a color indicating a “warning” status (e.g. yellow or some other user-recognized “warning” color) when the component's consumed lifetime is above the warning threshold but still below the lifetime. And finally, the progress bar can be changed to a color indicating an “error” status (e.g. red or some other user-recognized “error” color) when the component's entire lifetime has been consumed.

Whether or not a user can make changes in the control window 14 can be controlled through policy settings or user profiles that grant access rights. One advantage of the GUI 10 is that it provides a central resource for tracking component lifetimes. Now, multiple users of an analytical device no longer have to manually track a component's usage status. Instead, each user can consult the display window 12 and control window 14. This removes uncertainty as to whether other users had completed maintenance tasks on a component or not.

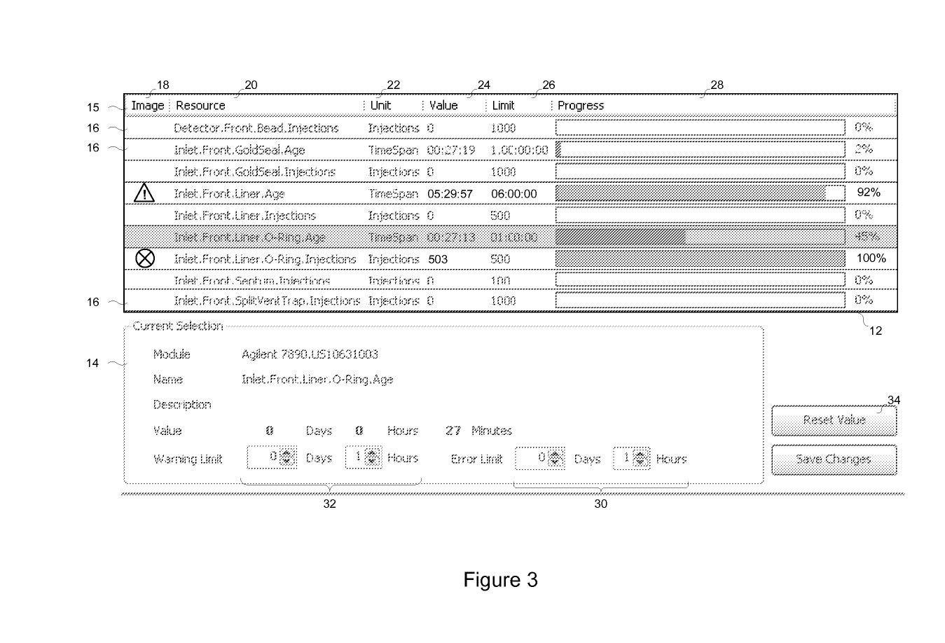

FIG. 3 shows one embodiment of the GUI 10 in an actual reduction to practice. Reference numbers have been added to identify different features in the GUI 10.

Although the present invention has been described in detail with reference to particular embodiments, persons possessing ordinary skill in the art to which this invention pertains will appreciate that various modifications and enhancements may be made without departing from the spirit and scope of the claims that follow.

What is claimed is:

1. A graphical user interface for monitoring an analytical device, comprising:
a first section that displays a plurality of maintenance information fields for a component in the analytical device, the component having a specified lifetime, the plurality of maintenance information fields including
an image representing a usage state of the component, and
a graphical representation of a consumed portion of the specified lifetime; and
a second section that sets a threshold used to determine the usage state.

2. A graphical user interface as in claim 1, wherein the plurality of maintenance information fields further includes:
a unit field that display units of measurement for the specified lifetime of the component.

3. A graphical user interface as in claim 2, wherein the units of measurement are defined by a user.

4. A graphical user interface as in claim 1, wherein the plurality of maintenance information fields further includes:
a usage field that displays the consumed portion of the specified lifetime in numeric form.

5. A graphical user interface as in claim 1, wherein the plurality of maintenance information fields further includes:
a limit field that displays the specified lifetime of the component in numeric form.

6. A graphical user interface as in claim 1, wherein the plurality of maintenance information fields further includes:
a name field that displays a unique identifier for the component.

7. A graphical user interface as in claim 1, wherein the graphical representation of the consumed portion is a progress bar.

8. A graphical user interface as in claim 7, wherein the color of the progress bar corresponds to the usage state of the component.

9. A graphical user interface as in claim 1, wherein the second section further includes
a function that sets the consumed portion of the specified lifetime to an initial value.

10. A graphical user interface as in claim 1, wherein the second section further includes
a lifetime field that enters the specified lifetime for the component.

11. A graphical user interface as in claim 1, wherein the second section further includes
a threshold field that enters a warning threshold for the component, such that when the consumed portion of the component exceeds the warning threshold, the usage state of the component changes.

12. A graphical user interface as in claim 10, wherein an alert is issued when the warning threshold is exceeded.

13. A method for monitoring a component with a specified lifetime in an analytical device, comprising:
displaying an image representing a usage state of the component;
displaying a graphical representation of a consumed portion of the specified lifetime; and
setting a threshold in the specified lifetime used to determine the usage state.

14. A method as in claim 13, further comprising:
displaying units of measurement for the specified lifetime of the component.

15. A method as in claim 14, wherein the units of measurement are defined by a user.

16. A method as in claim 13, further comprising:
displaying of the consumed portion of the specified lifetime in numeric form.

17. A method as in claim 13, further comprising:
displaying the specified lifetime of the component in numeric form.

18. A method as in claim 13, wherein the graphical representation is a progress bar.

19. A method as in claim 18, further comprising:
coloring the progress bar to correspond to the usage state.

20. A method as in claim 13, further comprising:
setting the consumed portion of the specified lifetime to an initial value.

21. A method as in claim 13, further comprising:
setting the specified lifetime for the component.

22. A method as in claim 13, further comprising:
issuing an alert to a user when the threshold is crossed.
